(19) United States
(12) Patent Application Publication
(10) Pub. No.: US 2013/0133408 A1
(43) Pub. Date: May 30, 2013

(54) Ultrasonic transducer for use in a fluid medium

(71) Applicant: Tobias Lang, Stuttgart (DE)

(72) Inventor: Tobias Lang, Stuttgart (DE)

(21) Appl. No.: 13/700,001

(22) PCT Filed: Mar. 23, 2011
(86) PCT No.: PCT/EP11/54466

§ 371 Date: Feb. 12, 2013

(30) Foreign Application Priority Data
May 25, 2010 (DE) 10 2010 029 283.4

(51) Int. Cl. G01N 29/02

(52) U.S. Cl. CPC G01N 29/02
USPC 73/64.53; 29/594

(57) ABSTRACT

An ultrasonic transducer for use in a fluid medium. The ultrasonic transducer includes at least one housing and at least one transducer core at least partially accommodated in the housing. The transducer core includes at least one acoustic-electric transducer element. At least one damping material is also accommodated in the housing. The damping material includes at least one matrix material, at least one first filler introduced into the matrix material, and at least one second filler introduced into the matrix material. The first filler has a lower specific gravity than the matrix material. The second filler has a higher specific gravity than the matrix material.

### FIELD OF THE INVENTION

The present invention relates to an ultrasonic transducer for use in a fluid medium.

### BACKGROUND INFORMATION

Ultrasonic transducers for various areas of application are believed to be in the related art. Thus, ultrasonic transducers are used, for example, in fluid media such as gases and/or liquids, in order to measure a fluid level and/or a flow characteristic, such as a mass flow rate or volumetric flow rate or a speed of the fluid medium. In particular, such ultrasonic transducers are used in the induction and/or exhaust tract of internal combustion engines. Alternatively, or in addition, ultrasonic transducers may also be used, for example, as distance sensors in air or other gases or liquids.

Ultrasonic transducers have, as a rule, at least one electroacoustic transducer element, for example, a piezoelectric transducer element, which is configured to convert electrical signals into ultrasonic signals or vice versa. Thus, ultrasonic transducers based on a piezoelectric ceramic, which may additionally include at least one impedance-matching layer, for example, a λ/4 impedance-matching layer, are known from the related art; the electroacoustic transducer element and the at least one optional impedance-matching layer forming a transducer core. This transducer core may be introduced into a housing, for example, a housing sleeve. A general problem with this is suppressing parasitic ultrasonic paths, which run through the materials of the sensor housing to the transducer core, or in the reverse direction. Such parasitic ultrasonic paths would otherwise distort the measuring signal, through which, for example, an ascertained value for the flow rate to be measured would often exceed a tolerance limit. Therefore, damping elements, which are positioned in the interior of the housing, are generally known from the related art, for example, the printed publications cited above. For example, decoupling elements may be provided between the transducer core and the housing sleeve.

In addition, in many instances, a cast damping material is provided inside the sleeve. In this context, various damping materials are know from the related art. Passive materials for impedance matching, for encapsulation, and in the form of lens materials for ultrasonic sensors, are discussed in H. Wang et al.: “Passive Materials for High Frequency Ultrasound Transducers,” 1999 SPIE Conference Proceedings, Society of Photo-Optical Instrumentation Engineers. Mixtures of metal oxides and plastics, as well as of tungsten and plastics, are used in this connection. Composite materials for ultrasonic damping, which contain an epoxy resin having titanium particles, are discussed in F. El-Tantawy et al.: “A novel ultrasonic transducer backing from porous epoxy resin-titanium-silane coupling agent and plasticizer composites,” Materials Letters 58 (2003) 154-158. Mixtures of tungsten particles and vinyl plastics as damping materials for ultrasonic transducers are also discussed in M. Grewe et al.: “Acoustic Properties of Particle/Polymer Composites for Ultrasonic Transducer Backing Applications,” IEEE Transactions on Ultrasonics, Ferroelectrics and Frequency Control, Vol. 37, No. 6, November 1990, 506-514.

In particular, in the development of flow sensors for gases, based on the measurement of ultrasonic echo times, there is the general problem that even when an impedance-matching layer is used, as a rule, only relatively small ultrasonic amplitudes may be produced in the gas to be measured, which means that the structure-borne noise components, which are superimposed with the ultrasonic signals and are transmitted through the sensor housing, have a particularly critical effect. On the other hand, in the presence of aggressive media, the ultrasonic transducers may not easily be suspended in the housing, decoupled from structure-borne noise by soft, and therefore, mostly not very robust materials. Even a protective foil, which covers a soft decoupling element situated behind it, mostly transmits a structure-borne noise component that is not insignificant.

Thus, there is still a need for damping materials, which decouple the ultrasonic transducer from structure-borne noise in an improved manner.

Examples of ultrasonic transducers, which may also be modified according to the present invention, within the scope of the present invention, are discussed in DE 203 02 582 U1, EP 0 766 071 A1, in DE 10 2007 010 500 A1, or in post-published DE 10 2009 046 144.2.

### SUMMARY OF THE INVENTION

Accordingly, an ultrasonic transducer and a method for manufacturing an ultrasonic transducer are provided, which eliminate the above-described disadvantages of known ultrasonic transducers. In particular, the present invention contributes towards providing improved damping of an ultrasonic transducer in such a manner, that structure-borne noise components are not necessarily limited with regard to their amplitude, but with regard to their emission time period, so that they are already decayed at the beginning of the receiving period for the actual useful signal. This allows more accurate measurement of the ultrasonic echo times and therefore, in turn, a more accurate flow measurement. However, as an alternative to, or in addition to, use in a flow measurement, the ultrasonic transducers of the exemplary embodiments and/or exemplary methods of the present invention may also be used for a multitude of other applications, for example, one or more of the above-mentioned applications. In particular, due to the excellent damping characteristics, the proposed ultrasonic transducers may be used in devices, which have at least two ultrasonic transducers that interact with each other. However, other set-ups are also theoretically feasible.

An ultrasonic transducer for use in a fluid medium, in particular, in a gas and/or in a liquid, is provided. This includes at least one housing and at least one transducer core at least partially accommodated in the housing. In this context, a housing is to be understood as an object, which has at least one interior chamber, for example, a hollow space, which is at least partially closed or, possibly, even partially open. The housing may be, for example, sleeve-shaped, in particular, at least substantially axially symmetric. The housing may achieve, in particular, the object of providing the ultrasonic transducer components accommodated in the interior chamber of the housing, with protection from mechanical and/or chemical influences. The housing may be made, for example, out of a plastic and/or a metallic material. However, ceramic housings are also theoretically feasible.

The transducer core includes at least one acoustic-electric transducer element. In this context, an acoustic-electric transducer element is to be understood as an element, which is configured to convert acoustic signals (for example, ultrasonic signals) into electrical signals, and/or vice versa. In particular, the acoustic-electric transducer element may be at least one piezoelectric transducer element, for example, a piezoelectric ceramic, which may have two or more electrodes. However, in principle, other embodiments are also conceivable. Furthermore, the transducer core may include at least one impedance-matching body, for example, at least one impedance-matching layer, for example, an impedance-matching layer as described in the above-mentioned related art. This impedance-matching layer may have an acoustic impedance, which lies between that of the acoustic-electric transducer element and that of the fluid medium and is ideally the geometric mean of these acoustic impedances. Moreover, additional elements may be provided in the transducer core, for example, one or more thermal matching layers, which are set up, for example, to adjust an expansion coefficient of the acoustic-electric transducer element to an expansion coefficient of an impedance-matching layer or of, in general, an impedance-matching body. Such superstructural elements are known.

Thus, the transducer core may have a multipart construction, including the acoustic-electric transducer element and the optional impedance-matching body on the side of the transducer element facing the fluid medium, as well as, as a further option, at least one thermal matching body between the impedance-matching body and the acoustic-electric transducer element. Examples are explained in further detail in the following.

At least one damping material is also accommodated in the housing. For example, this damping material may form at least one damping element or form a part of such a damping element. For example, the damping material may radially surround the acoustic-electric transducer element and/or the transducer core. In addition, the damping material may also be accommodated on a side of the transducer core and/or of the acoustic-electric transducer element, which side faces away from the fluid medium. In particular, the damping material may come into direct contact with the acoustic-electric transducer element at at least one location. In particular, the damping material may be accommodated between the acoustic-electric transducer element and/or the transducer core and the housing, for example, in a space between the housing and the transducer core. Different embodiments are described below in even further detail.

The damping material includes at least one matrix material, thus, a material, which may form a predominant part of the total damping material, and which may form, for example, a homogeneous matrix. In particular, the matrix material may include at least one plastic, which may be, a thermosetting plastic and/or an elastomeric material. As an alternative, or in addition, however, the use of a thermoplastic material is also theoretically conceivable. In particular, the matrix material may be developed in such a manner, that it essentially holds together the damping material and/or a damping body made of the damping material, by, for example, acting as a bonding material between other components of the damping material.

The damping material further includes at least one first filler introduced, e.g., mixed, into the matrix material, and at least one second filler introduced, in particular, mixed, into the matrix material. In particular, the fillers may be present in particulate form, so that for example, particles of the fillers do not need to contact one another, but the cohesion is produced by the matrix material. In particular, the fillers may be distributed essentially uniformly, e.g., dispersed, in the matrix material. Apart from the idea of using two different fillers, an important aspect of the exemplary embodiments and/or exemplary methods of the present invention is that the first filler (although a plurality of first fillers may also be provided) have a lower specific gravity (i.e., a lower density) than the matrix material, and that the second filler have a higher specific gravity than the matrix material.

As explained above, the damping material may be introduced, in particular, into at least one space between the housing and the transducer core. In particular, at the back, the transducer core may be braced directly or indirectly against at least one support element, in particular, against at least one support element of the housing, in a direction opposite to a radiation direction of the ultrasonic transducer. For this purpose, the housing may be constructed to be closed at the back, i.e., on the side facing away from the fluid medium. Alternatively, or in addition, to complete closure of the housing on the side facing away from the fluid medium, one or more openings may also be provided, through which rearward expansion of the transducer core and/or of further ultrasonic transducer components accommodated in the housing is possible; however, support should still be provided at the same time. However, as an alternative, or in addition, the at least one support element may also include one or more support elements projecting from the edge of the housing into the interior of the ultrasonic transducer, for example, one or more support collars, flanged caps, wings folded inwards, or the like. Different exemplary embodiments are described below in further detail.

The matrix material may include, in particular, a plastic material. In particular, the matrix material may include a curable plastic in, for example, a cured state. In this context, a curable plastic is to be understood as a plastic, which has at least one liquid, flowable state and at least one cured state, in which the plastic essentially does not change or at least no longer macroscopically changes its shape under the influence of forces normal during operation of the ultrasonic transducer. For example, the plastic may change its chemical form while curing, in that, for example, cross-linking of the plastic takes place during the curing. However, alternatively, or in addition, a phase transition may also take place. The matrix material may include, for example, a plastic material, which has, in the cured state, a hardness between 10 and 100 Shore A. Shore A hardnesses between 20 and 70 may be particularly used, for example, between 50 and 60, and particularly which may be, 55, for example, two-component silicone having a Shore A hardness of 55. In particular, the plastic may include at least one epoxide material and/or at least one silicone material. In general, e.g., curable elastomeric materials may be used. In principle, the curable plastic may have any curing process at all. For example, chemically-induced curing may take place. However, alternatively or additionally, thermal and/or photochemical curing processes may also be used. The plastic may be, for example, a single-component and/or also a multicomponent plastic. From this, a hardening material may be provided which is added, for example, to a second material of the plastic in order to start a curing process chemically.

In particular, two-component silicone materials may be used. In this context, as is explained below in further detail, in the non-cured state, the viscosity of the matrix material and/or of the entire damping material plays a crucial role in many cases. In this context, it particularly may be that if, in the non-cured state, the matrix material has a viscosity of at least 200 mPas, in particular, at least 500 mPas. Such a viscosity may be achieved, for example, by suitable selection of the matrix material and/or by suitable chemical modification of the matrix material. In this context, a non-cured state is generally to be understood as a state, in which the matrix material and/or the damping material are deformable in such a manner, that they may be introduced into the housing. In this connection, e.g., a casting process may be used, as explained below in further detail. In particular, the matrix material may have thixotropic properties in the non-cured state. This means that in a state in which no shear forces or only small shear forces act upon the matrix material, the matrix material may have a high viscosity, whereas in response to the action of shear forces or higher shear forces, a lower viscosity is produced.

The first filler has a lower specific gravity than the matrix material. In particular, the first filler may have a maximum specific gravity of 0.9 times, which may be, 0.5 times, and particularly which may be, 0.1 times the specific gravity of the matrix material, or less. The first filler may include, in particular, one or more of the following fillers: hollow bodies, in particular, hollow spheres; hollow bodies having a deformable (for example, plastic and/or elastic) shell, in particular, a plastic shell made of, for example, polyethylene or another plastic material; hollow plastic bodies, in particular, hollow, gas-filled, plastic bodies, in particular, hollow, gas-filled, plastic spheres; hollow glass bodies, in particular, hollow, gas-filled glass spheres.

In particular, as explained above, the first filler may be a particulate filler, thus, a filler which includes a plurality of particles. The first filler substance may include, in particular, particles, in particular, hollow bodies having, under normal conditions, a maximum size (for example, an equivalent diameter, in particular, a d₅₀ equivalent diameter) of 200 μm, which may be, 100 μm, and particularly which may be, 20 μm, or less than 20 μm. The first filler may have, in particular, a specific gravity of no more than 1.0 g/cm³, in particular, no more than 0.5 g/cm³, which may be, not more than 0.1 g/cm³, and particularly which may be, no more than 0.08 g/cm³.

Likewise, the second filler may include one or more kinds of particles. In particular, the second filler may include one or more of the following fillers: a metal, in particular, tungsten; tungsten carbide; copper; nickel; nickel brass; bronze; a chemical compound including a metal, for example, a metal oxide having, for example, one of the above-mentioned metals; a powdery filler, in particular, a metal powder and/or a ceramic powder. The second filler may have, in particular, a specific gravity of at least 5 g/cm³, which may be, at least 10 g/cm³, and particularly which may be, at least 15 g/cm³. The second filler may include, in particular, a powder having a particle size (for example, in turn, an equivalent diameter, for example, a d₅₀ equivalent diameter) of no more than 50 μm, which may be, not more than 10 μm, and particularly which may be, not more than 5 μm, and in particular, not more than 2 μm. A weight percentage of the second filler may be, in particular, at least 15%, which may be, at least 50%, and particularly which may be, at least 66%, of the damping material. A weight percentage of the first filler may be, in particular, at least 0.05%, which may be, at least 0.15%, and particularly which may be, at least 0.5%, of the damping material.

In addition to an ultrasonic transducer according to one or more of the above-described embodiments, a method for manufacturing an ultrasonic transducer is also provided. In this context, it may be, in particular, an ultrasonic transducer according to one or more of the above-described embodiments, so that with regard to possible embodiments of the ultrasonic transducer, reference may be made to the above description. However, in principle, other ultrasonic transducers are also manufacturable according to the proposed method. In this context, the method steps proposed in the following may be executed in the order described, but in principle, they may also be executed in a different order. Furthermore, additional method steps not mentioned may also be implemented. Moreover, one or more of the mentioned method steps may be executed concurrently in time, overlapping in time, or repeatedly individually or in groups.

In the proposed method, at least one transducer core is inserted at least partially into a housing. The transducer core includes at least one acoustic-electric transducer element. In addition, at least one damping material is introduced into the housing. At least one matrix material and at least one first filler introduced into the matrix material, as well as at least one second filler introduced into the matrix material, are contained in the damping material. In this context, the introduction of the fillers may also be part of the proposed method. In this context, the first filler has a lower specific gravity than the matrix material, and the second filler has a higher specific gravity than the matrix material. In particular, the matrix material may include at least one curable material, where in a non-cured state (which may also include a not completely cured state, see above), the curable material may be introduced into the housing and subsequently cured.

Prior to introduction into the matrix material, which may take place prior to the introduction of the damping material into the housing, at least one of the fillers, in particular, the first filler, may also be pretreated using one or more method steps. Thus, in particular, at least one of the fillers, in particular, the first filler, may initially be pre-expanded by a thermal treatment and subsequently introduced into the matrix material and/or into the damping material. This method is particularly suitable for fillers, which include hollow bodies, for example, hollow plastic bodies and/or hollow glass bodies of, for example, the kind described above. Prior to the pre-expansion, the filler, for example, the first filler, may be wetted by, in particular, at least one component of the damping material, in particular, by at least one component of the matrix material, for example, a resin component of the silicone, in order to be subsequently subjected to the pre-expansion. In addition, or alternatively, expansion of the fillers, in particular, of the first filler, may also be carried out after introducing the damping material into the housing, for example, prior to or during the curing of the matrix material.

In particular, a casting process, for example, a vacuum casting process, may be used for introducing the damping material and/or the matrix material into the housing. In particular, a vacuum casting process may have the advantage that degassing of the damping material and/or the matrix material may take place simultaneously to and/or immediately prior to the introduction into the housing. The damping material and/or the matrix material may be gelled after the introduction into the housing.

Therefore, in the proposed ultrasonic transducer and the proposed method, the damping material includes a matrix material, for example, a damping plastic, having at least two admixtures in the form of the at least two fillers, of which one is lighter and the other is heavier than the matrix material. In particular, a silicone is possible as a matrix material. Metal particles are, in particular, suitable as a heavier admixture. The lighter admixture may take the form, for example, of hollow spaces. These are, for example, directly incorporated inside of the matrix material or also in an additional jacket in the form of, for example, hollow plastic bodies and/or hollow plastic spheres.

The damping materials, which have metallic admixtures and are known from the related art, do dampen the post-vibration of the acoustic-electric transducer element comparatively effectively, since the high density and, therefore, high acoustic impedance effectively adapt them to it, but they transmit a correspondingly large amount of structure-borne noise to the housing. Cellular plastics or damping materials, which have hollow plastic spheres and do not have metal particles do decouple quite effectively, but due to the correspondingly low density and, therefore, low acoustic impedance, they also absorb less energy from the acoustic-electric transducer element, which means that even after brief, pulse-type excitation, the transducer element undergoes vibrations for a long time, which may be transmitted within this longer time period via other structure-borne noise paths. In the case of using a protective foil over the acoustic-electric transducer element, such decoupling is bypassed by this foil and is then, as a rule, useless. Cellular plastics or damping materials, which have hollow plastic spheres and do not have metal particles, also damp radially-vibrating piezoelectric elements and piezoelectric elements vibrating along their thickness comparatively poorly and are, at best, suitable for damping vibrations coupled with relatively low acoustic impedance, as are present, for instance, in the case of a diaphragm resonator in, e.g., park pilot systems.

Surprisingly, as further verified below by comparison measurements, it has now been revealed by the present invention that, in particular, the combination of heavy and light fillers (in each instance, based on the matrix material) has especially good damping characteristics. In this respect, this is unexpected, since in the case of admixing lighter and heavier fillers, the acoustic impedance is, from a macroscopic viewpoint, mostly dominated by the heavier fillers, particularly when the heavier fillers are markedly heavier than the matrix material and assume a relatively high level within the total damping material. Thus, one could assume that the additional admixture of lighter fillers should produce scarcely any change. However, contrary to this assumption, it turns out that only the combination of such fillers produces effective decoupling. For example, the first filler may form regions in the damping material, which have a lower acoustic impedance than the matrix material. In the damping material, the second filler may form regions (for example, once again, particle inclusions), which have a higher acoustic impedance than that of the matrix material. In this manner, the combination of a plastic with enclosed regions of higher and lower impedance may produce effective decoupling. In particular, the ultrasonic converter may be formed in such a manner, that the housing has at least one coupling opening to the fluid medium, via which ultrasonic signals may be transmitted to the fluid medium and/or may be received from the fluid medium. This coupling opening may be closed, in particular, by a protective foil. Using the damping material, the negative effects of the protective foil may be at least partially compensated for, and at the same time, the advantages of such a protective foil may be utilized. The more effective damping and/or decoupling of an ultrasonic transducer of the present invention results in, on the whole, less damping material being needed than in the case of conventional ultrasonic transducers, in particular, a lower volume of damping material. In this manner, the lift acting upon the connecting wires due to thermal expansion of the damping material, for example, of the cast damping material, is markedly reduced. For example, the amount of damping material in the housing may be reduced in such a manner, that the surface of the acoustic-electric transducer element, for example, the piezoelectric surface, is just covered, so that it is covered, for example, by no more than 1 mm of the damping material. In principle, coverages of less than 1 mm, for example, of less than 0.5 mm, are also possible. Using a surface of the acoustic-electric transducer element that is just covered, including the associated contact points, the latter are effectively protected and are markedly more robust, for example, with regard to temperature shocks, than in the case of a higher damping material charge of the housing.

Exemplary embodiments of the present invention are depicted in the figures and are explained in more detail in the description below.

### BRIEF DESCRIPTION OF THE FIGURES

FIG. 1 shows an exemplary embodiment of an ultrasonic sensor system for determining flow characteristics.

FIGS. 2, 3, 4, 5, and 6 show different embodiments of ultrasonic transducers of the present invention.

FIGS. 7A and 7B show signal characteristics of the ultrasonic transducers in a sensor system, e.g., according to FIG. 1, for different damping materials of the present invention and not of the present invention.

FIG. 8 shows a schematic composition of a damping material of the present invention.

FIG. 9 shows a schematic method for manufacturing a damping material according to the present invention.

### DETAILED DESCRIPTION

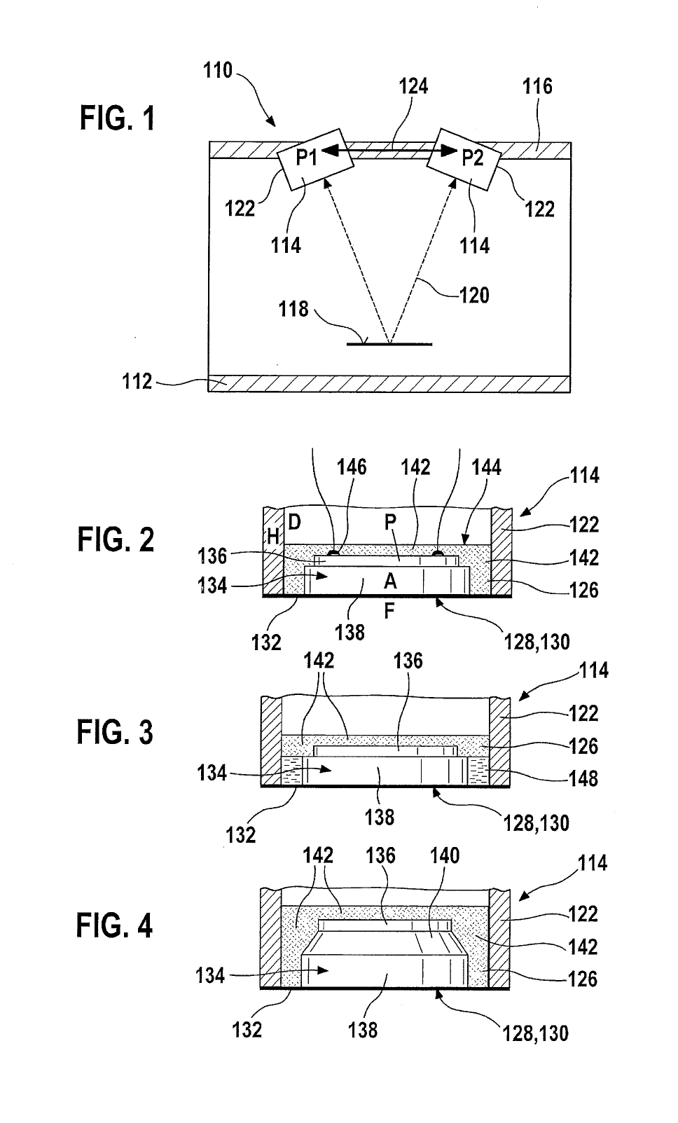

An exemplary embodiment of a sensor system 110, which may be used, for example, for determining flow characteristics of a fluid medium in a flow pipe 112, is represented in FIG. 1. In the exemplary embodiments illustrated, sensor system 110 includes two ultrasonic transducers 114, which are mounted in a pipe wall 116 of flow pipe 112, and which are denoted by P1 and P2 in FIG. 1. Sensor system 110 may be used, for example, for ascertaining a flow rate through flow pipe 112. The two ultrasonic transducers 114 (P1 and P2) mounted in an offset manner in the flow direction transmit ultrasonic pulses to each other directly or, as illustrated in FIG. 1, via a reflecting surface 118. This desired signal propagation of the ultrasonic signals is also referred to as a useful signal path 120 and is illustrated in FIG. 1 by a dashed line. In addition, structure-borne noise is transmitted between the two ultrasonic transducers 114 via pipe wall 116 and/or via housings 122 of ultrasonic transducers 114. In FIG. 1, this structure-born noise transmission is designated symbolically by solid-line arrow 124.

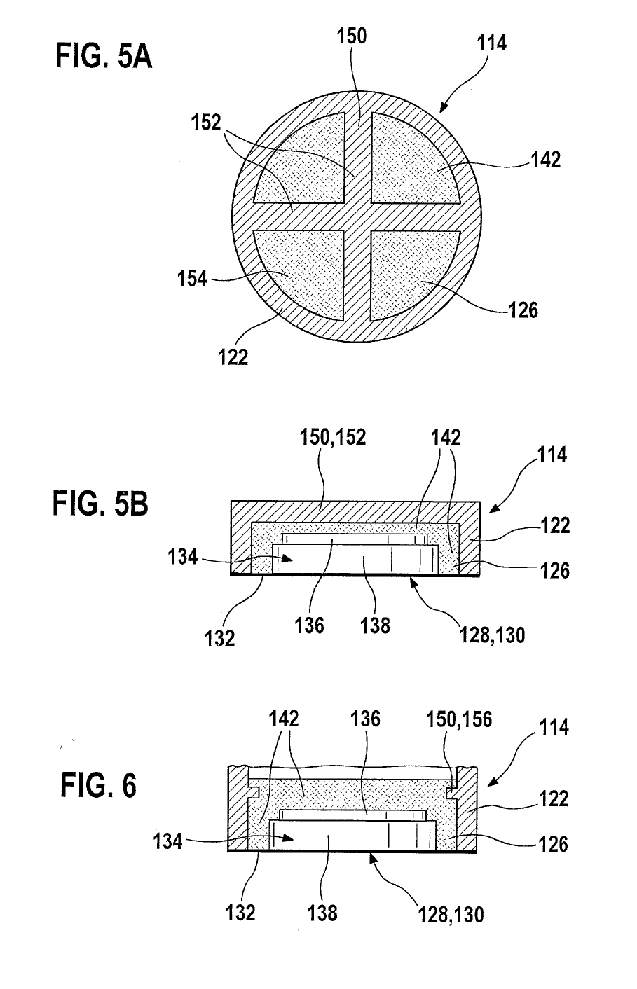

Different ultrasonic transducers 114 are schematically represented in FIGS. 2 through 6. In this context, FIGS. 2 through 4, 5B and 6 each show sectional views of ultrasonic transducers 114 from the side, whereas FIG. 5A shows a backside view of the ultrasonic transducer 114 shown in FIG. 5B, from a side facing away from the fluid medium. Ultrasonic transducers 114 each include a housing 122 having an interior chamber 126. Housings 122 are, for example, substantially sleeve-shaped and have, in the direction of the fluid medium, a coupling opening 128, at which a radiating surface 130 for emitting and/or receiving ultrasonic signals is formed. In the exemplary embodiment illustrated, radiating surface 128 is covered by a protective foil 132, for example, a protective plastic film. In addition, at least one transducer core 134 is accommodated in interior chamber 126. The primary acoustic-electric conversion, for example, electromechanical conversion, takes place inside of an acoustic-electric transducer element 136 included in transducer core 134. In this connection, it may be, for example, an electrically contacted, piezoelectric ceramic, which is why, in FIG. 2, it is also designated by P, without limiting any further, possible embodiments. Furthermore, acoustic-electric transducer element 136 is acoustically impedance-matched to the medium to be measured, by an impedance-matching layer 138, which, in FIG. 2, is also referred to as A. In FIG. 2, protective foil 132 is referred to as F. In addition, as exemplarily shown in FIG. 4, transducer core 134 may include further elements, for example, at least one thermal matching body 140, in particular, between acoustic-electric transducer element 136 and impedance-matching layer 138. Various other embodiments are possible. Transducer core 134 is accommodated in the housing 122 exemplarily represented as sleeve-shaped in the figures, and is covered by protective foil 132 in the direction of the medium to be measured, in order to protect it from moisture, aggressive media and abrasive particles.

Furthermore, a damping material 142, which may also be designated as damping material D, is positioned in interior chamber 126, that is, in the interior of the transducer, in order to damp transducer core 134. This damping material 142 may be implemented, for example, in the form of a silicone and/or as a molding compound. As shown in the exemplary embodiments in FIGS. 2, 4, 5A, 5B and 6, damping material 142 may completely fill up a space between transducer core 134 and housing 122 up to a fill level 144. Fill level 144 may be selected, so that a surface of transducer core 134 pointing away from the fluid medium and/or terminal contacts 146 may be covered completely by damping material 142. Alternatively, or in addition, wider elements may still be introduced into the space between transducer core 134 and housing 122, as shown by example in the exemplary embodiment in FIG. 3. In this case, a stabilizing element 148 may still be accommodated in the space. For example, this stabilizing element 48 may include a material made of a liquid silicone (for example, a liquid silicone rubber, LSR). Stabilizing element 148 may be used, for example, for centering and/or stabilizing transducer core 134, in particular, impedance-matching layer 138, and/or for fulfilling, in the end product, the function of a compensating element between transducer core 134, in particular, impedance-matching layer 138, and housing 122, which means that, for example, deformations inside of ultrasonic transducer 114 may be reduced. In addition, as described above, at least one further material and/or at least one further element may be accommodated in transducer core 134. In this context, it may be, for example, at least one thermal matching body 140, as explained above. This matching body or this layer may be used, in order to keep deformations generated by the thermal expansion of impedance-matching layer 138 away from acoustic-electric transducer element 138, for example, from the piezoelectric element. To this end, this thermal matching body 140 should have an expansion coefficient close to that of acoustic-electric transducer element 136, for example, about 10 ppm/° K or less. In addition, or as an alternative, this thermal matching body 140 may be used for limiting the ability of acoustic-electric transducer element 136, e.g., of the piezoelectric element, to bend. For, in addition to the primarily used, planar and thickness modes, thinner piezoelectric elements have, in particular, flexural vibration, which couples into surrounding damping material 142 at a different acoustic impedance. For the most part, it is difficult to adjust a damping material, such that all three types of vibration are effectively damped. In addition, thermal matching body 140 may also have acoustic coupling effects, in particular, it may further improve the matching of impedance to the medium to be measured, since as a rule, the corresponding material may have an acoustic impedance between that of the acoustic-electric transducer element and that of impedance-matching layer 138. In this respect, this thermal matching body 140 may also be regarded as part of impedance-matching layer 138 or an impedance-matching body, which are then to be divided up into different regions with regard to their material properties and/or have a gradient or a stepped change in the properties. Some of these regions may also satisfy other functions, for example, further improving the adhesion to acoustic-electric transducer element 136 and/or to the piezoelectric electrode.

As illustrated, in particular, in FIG. 5, ultrasonic transducer 114 may further include at least one stabilizing element and/or at least one support element 150. Using this support element 150, the interior of ultrasonic transducer 114 may be stabilized with respect to a pressure applied by the measured medium, in that this pressure is transmitted through foil 132, transducer core 134 and damping material 142 to housing 122. As shown in FIGS. 5A and 5B, support element 150 may include a rear closure of housing 122, which may be implemented completely or partially. In FIGS. 5A and 5B, this is implemented by crossbeams 152, between which openings 154 may be situated. On the other hand, a circumferential rim 156, which may also take the form of a bead or something similar, is provided in the exemplary embodiment according to FIG. 6. Various other embodiments, which allow a front-side pressure to be transmitted to housing 122, are conceivable. Thus, support element 150 may have, for example, necked-down portions, recesses, support surfaces or support ribs, or combinations of the above-mentioned and/or other support elements 150. However, overly rigid or even complete sealing of housing 122 is, as a rule, unfavorable, since then, the thermal expansion and/or contraction of damping material 142 in response to temperature changes may only be relieved in the direction of the measured medium, which would then overload protective foil 132 or its attachment to housing 122. The above-mentioned measure of support element 150 may be implemented in various combinations with the previously listed variants of ultrasonic transducer 114.

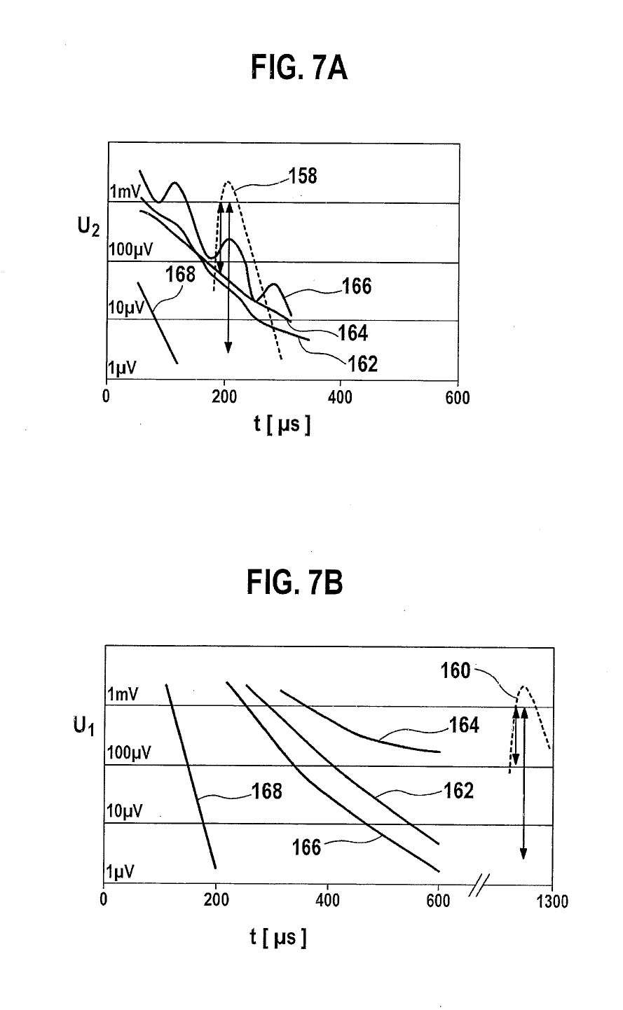

Time characteristics of transmission and receiving events, as well as of the signal amplitudes, are represented schematically in FIGS. 7A and 7B. In this context, by way of example, a signal, for example, a voltage signal, at second ultrasonic transducer 114 (P2) in FIG. 1 is shown in FIG. 7A, and a signal U1 at first ultrasonic transducer 114 (P1) in FIG. 1 is shown in FIG. 7B. Signals U2 and U1 are each plotted as a function of a time t in μs. In this context, in each instance, the transmission time at ultrasonic transducer P1 is defined as the zero point of the time. A useful signal then arrives, for example, 200 μs later at the other transducer P2 in question, as a function of the measured medium, temperature, spacing of ultrasonic transducers 114, flow rate, and similar parameters. In FIG. 7A, the useful signal at ultrasonic transducer P2 is denoted by reference numeral 158, and in FIG. 7B, the useful signal at ultrasonic transducer P1 is denoted by reference numeral 160. The ultrasonic measurement in the opposite direction, that is, at ultrasonic transducer P1, is started, for example, after 1 ms, in that at P2, an ultrasonic signal is transmitted which is received at P1 in, for example, approximately 1200 μs (curve 160 in diagram 7B).

In addition, the behavior of four different damping materials is illustrated in FIGS. 7A and 7B. In this context, curves 162 to 168 show different interference signals, thus, signals that are not caused by the actual useful signals 158 and 160. Curve 162 shows an interference signal for silicone as the damping material 142, curve 164 shows an interference signal for silicone having hollow elastomeric spheres as a filler, curve 166 shows an interference signal for silicone and tungsten particles as a damping material 142, and curve 168 shows an interference signal for silicone as a matrix material, having hollow elastomeric spheres and tungsten as fillers. Thus, FIGS. 7A and 7B show the behavior of four different damping materials 142, using curves 162 to 168. In this context, hollow plastic spheres of the type Expancell® of the company Akzo Nobel are used. This is explained below in further detail by way of example. Tungsten is introduced in the form of tungsten particles.

As FIG. 7B indicates, the post-vibration after the transmission event at P1 is only critical in the case of very weak damping. In this case, P1 would still continue to vibrate while the signal from P2 arrives, and therefore, would distort the signal to be measured. Such weak damping occurs, for example, when an overly flexible silicone is used, and/or when damping material 142 is too light due to added, hollow spheres and is, therefore, mismatched to acoustic-electric transducer element 136, for example, to the piezoelectric element, with regard to impedance. Otherwise, the post-vibration is less critical than the crosstalk of the structure-borne noise between the two ultrasonic transducers 114. The crosstalk from P1 to P2 is critical for both silicone and silicone having hollow plastic spheres or tungsten particles, that is, neither the hollow spheres, nor the tungsten produce an improvement. These additives even show a tendency to worsen the crosstalk, since in the case of hollow spheres, the piezoelectric element is damped too little (acoustic mismatching), and since in the case of tungsten, the acoustic matching is so effective, that the structure-borne noise increases, as well. However, silicone having fillers in the form of hollow spheres and tungsten shows a completely different behavior, as results from curve 168, which behavior manifests itself primarily in a very rapid decrease in the vibrational energy. Only in this case is the temporal receiving window of 200 μs in FIG. 7A, that is, the receiving window until the arrival of useful signal 158, free of structure-borne noise components, which are transmitted directly from ultrasonic transducer P1 to ultrasonic transducer P2. To be sure, the post-vibration of acoustic-electric transducer element 136 is, as a rule, less critical, but in return, the method of functioning of the damping material may be understood more effectively in light of this parameter. First of all, it is surprising that the hollow-sphere admixtures, together with the tungsten, influence the post-vibration much more markedly than the tungsten filler alone. Evidently, tungsten is needed for actually coupling the sound into the damping material. Silicone and hollow spheres alone probably damp effectively, as soon as sound is first in damping material 142, but due to the acoustic mismatching, the sound simply does not enter into the material, and therefore, it is also not damped. On the other hand, silicone having only tungsten does appear to absorb the sound energy, but not effectively enough to damp it. In this case, the vibrational energy is possibly even returned again to acoustic-electric transducer element 136. The oscillating structure-borne noise characteristic of curve 166 in this material points to the last hypothesis. Only the silicone matrix material having the heavy, acoustically rigid tungsten filler and the light, acoustically flexible, hollow-sphere filler is capable of absorbing the vibrational energy (using the heavy tungsten filler) and damping it (using the light filler in the form of hollow spheres). In the case of the latter damping, not only the dispersion at the fillers, but also dissipation by diabatic/adiabatic compression of the hollow spheres presumably play a role.

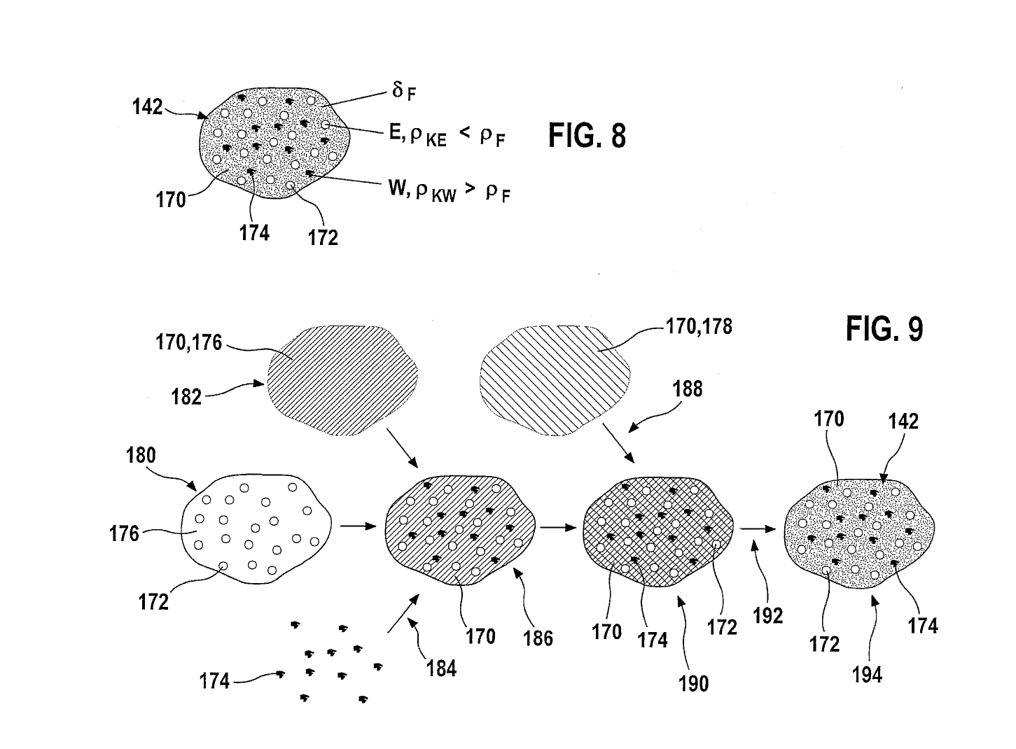

Finally, possible damping materials 142, as well as their manufacture and processing, are described by way of example with the aid of FIGS. 8 and 9. As explained above, damping material 142 of the exemplary embodiments and/or exemplary methods of the present invention includes at least one matrix material 170, at least one filler 172 (which, in FIG. 8, is represented by circles not filled in and is also denoted by “E”), as well as at least one second filler 174 (which, in FIG. 8, is symbolically represented by filled-in particles and also denoted by “W”). In samples, an effectively adhering 2K silicone, which has a hardness of 55 Shore A and is adjusted to the operative temperature range of −40° C. to 140° C., is used as a matrix material (also referred to as a base material) of damping material 142. It should be pointed out that the exemplary embodiments described in the following are only to be understood as exemplary, and that matrix materials 170 and fillers 172, 174 different from the materials illustrated may be used.

In a first variant, hollow plastic spheres are used as a first filler 172. As was able to be observed in some samples, these hollow plastic spheres may possibly be, together with a second filler 174 in the form of heavier particles, adequate for a sufficient reduction in structure-borne noise. However, when damping material 142 is degassed, for example, in a vacuum, sufficient decoupling is not apparent due to the lack of hollow spaces, and therefore, due to the lack of first filler 172. The weight percentage of the utilized, hollow plastic spheres is 1%. The hollow plastic spheres are also referred to as “microballoons.” These may be added, for example, to the resin component of the silicone. To that end, pre-expanded, hollow, synthetic vinylidene chloride resin spheres (vinylidene chloride-acrylonitrile copolymer) filled with butane gas, which are manufactured by the company Expancell under the brand marking of the same name, may be used in the second variant.

As a second filler 174, tungsten metal powder having a particle size of app. 2 μm is also mixed into the resin component at a weight proportion of 2:1, before the hardener is added. This is shown by example in FIGS. 8 and 9. While FIG. 8 exemplarily shows finished damping material 142, FIG. 9 shows the course of a possible method for manufacturing this damping material 142. In this context, reference numeral 176 designates a resin component of matrix material 170, and reference numeral 178 designates a hardener component of matrix material 170. After first filler 172 and, subsequently or previously, second filler 174 are mixed with resin component 176, hardener component 178 is added.

As an option, pre-expanded, hollow plastic spheres may be used as a first filler 172. The use of pre-expanded, hollow plastic spheres is advantageous in the curing phase of damping material 142. Otherwise, considerable volume changes, which could negatively influence the cohesion of damping material 142 and, ultimately, the material properties, would possibly occur during the curing. In particular, in the technique of the method, it must be ensured that the hollow plastic spheres first expand before the silicone crosslinks, in order that no stresses occur due to expansion of the hollow spheres within the already crosslinked silicone. During a subsequent temperature treatment step in the form of, e.g., tempering, the latter could be reduced in the form of compression of the hollow spheres. Corresponding process control is indeed possible, but it is not easy to control in practice.

Therefore, in the method shown in FIG. 9, the hollow plastic spheres may be not mixed into the silicone directly, but are first wetted, for example, by resin component 176 of matrix material 170. In FIG. 9, the wetted, hollow plastic spheres are also referred to as master batch 180. The hollow plastic spheres wetted in such a manner or, in general, the first filler 172 wetted in such a manner, i.e., a first filler 172, which is wetted by at least one component of matrix material 170, is then pre-expanded by the action of temperature. This so-called master batch is then mixed with the remaining resin component 176, for example, the silicone resin, or added to it, simultaneously to, prior to or after adding second filler 174.

The silicone provided with heavy and light fillers in such a manner may be subjected to at least one degasification step. For example, degasification may be accomplished by vacuum, in order to prevent uncontrollable blistering. A vacuum casting process for, in particular, introducing the non-cured matrix material 170 into housing 122, is also advantageous.

As a rule, the necessary mixture ratios are a function of, inter alia, the geometry of acoustic-electric transducer element 176 and/or transducer core 134. For example, thicker piezoelectric disks (e.g., piezoelectric disks having a thickness of 2 mm and a diameter of 8 mm) may be effectively damped, using the above-described ratios; the given level of hollow plastic spheres more likely indicating the limit that may just still be cast, and also being able to be markedly reduced with respect to it without resulting in deterioration of the decoupling of the structure-borne noise. However, the tungsten level should not be reduced too much. With half the amount of tungsten (mixture ratio of 1:1), crosstalk that is, at a maximum, slightly reduced could result, but for that, its time characteristic already lasts markedly longer.

In the case of a thinner piezoelectric element or acoustic-electric transducer element 136 (having, for example, dimensions of 8 mm for a diameter and 0.2 mm for a thickness), flexural vibrations, which act upon surrounding damping material 142 with a lower acoustic impedance, are produced in addition to the primarily used, planar and thickness vibrations. Because of this lower impedance and the additionally lower mass of the piezoelectric element, different mixture ratios, in which less hardener component 178 is added, and in which the tungsten level or the level of second filler 174 is reduced, for example, to 1:1, are advantageous for this application case; less added hardener component producing less crosslinking and a reduced Shore hardness. A different case is present again, when such a piezoelectric element is placed onto an impedance-matching body 138 and, optionally, onto at least one thermal matching body 140, as shown in FIG. 4, which means that the piezoelectric mass itself remains small, but the ability of the piezoelectric element or acoustic-electric transducer element 136 to bend is suppressed.

As described above, a multitude of other first fillers 172 may be used as an alternative to the hollow plastic spheres. For example, hollow glass spheres may be used, but due to their hard shell, they are, as a rule, not compressible and are therefore markedly less effective. Accordingly, first fillers 172, in which at least one shell is provided in a solid state but may be compressible or deformable, may be used; this shell enclosing at least one fluid medium, which may be, at least one gas.

An aspect, which is, as a rule, important, is the particle sizes of the particles of first filler 172, for example, of the hollow spheres, and/or the particle sizes of second filler 174, for example, of the metal particles and/or ceramic particles. At least in Newtonian fluids, and in the case of spherical fillers, viscosity η, descent or ascent velocity v, particle radius r and the densities of the fillers (in the following, generally referred to as ρ_{K}, for example, ρ_{KE} in FIG. 8 for first filler 172 and ρ_{KW} for second filler 174) and ρ_{F} of fillers and matrix material 170 (in particular, a fluid, e.g., silicone) are linked as follows:

$$η = \frac{2 \cdot g \cdot {r}^{2}}{9 \cdot v} \cdot ( {p}_{K} - {p}_{F} ) .$$

This means that the viscosity should be selected to be high enough that damping material 142 does not separate prior to or during the curing, but low enough that the material still remains sufficiently workable, for example, castable. On the other hand, the fillers should be selected to be as small as possible. On the other hand, the filler size influences, in turn, its scattering ability with respect to ultrasonic waves. Optimum scattering would theoretically be achieved in the range of the wavelength of the ultrasonic frequency used, which, however, in the case of several hundred kHz and the typical sonic velocities in plastics, would correspond to particles that are much too large. Ultimately, a fine adjustment of the particle sizes is to be sought as a compromise between preventing separation and optimizing scattering.

For example, for the tungsten particles, a particle size of 10 μm may be assumed, and a sedimentation time of 1 h or more may be required, which constitutes a realistic time in, for example, a charging and oven process. Then, in the case of an assumed fluid density of, e.g., 1 g/cm³, it may easily be calculated that the viscosity through the charging and oven process should be at least 500 mPas, in order to prevent separation. If the viscosity is already greater than this value, then the grain size of the particles may also turn out larger. Due to the small difference in density ρ_{K}−ρ_{F}, the hollow plastic spheres may be markedly larger than the tungsten particles, without separation taking place. Typical average diameters of the hollow plastic spheres may be, for example, less than 10 μm (unexpanded) and 60 μm or less (expanded). Furthermore, thixotroping of matrix material 170 and/or of one or more of the components 176, 178 of matrix material 170 may be used. Thixotroping of the silicone may be accomplished, for example, by adding pyrogenic silicic acid. In addition, or alternatively, other fillers such as silicates or ceramic particles may also be used, even in combination with markedly heavier metal particles. The resulting thixotroping increases the viscosity; the shear viscosity still being able to be relatively low, since the silicone then deviates markedly from a Newtonian fluid. By this means, larger fillers may also be kept in suspension, while effective castability may still be provided by the shear forces in the range of, for example, a dispensing needle for charging, since in this range, the viscosity is temporarily reduced and, at least under vacuum, it is also possible to fill up narrower and deeper openings.

In order to improve, in particular, optimize, material properties of damping material 142, it is also useful to gel damping material 142 and/or one or more of the components 176, 178 of matrix material 170 and/or the entire matrix material 170. This may be accomplished by temperature treatment, for example, at 100° C. for a half hour, followed by curing at 150° C., or else (depending on the silicone base material used) in the form of a different temperature profile, which does not move immediately to the final curing temperature. This measure improves both the internal material properties (e.g., cohesion, adhesion of silicone to the fillers, prevention of brittleness) and the external properties, such as the formation of a closed surface and the adhesion.

As explained above, the material examples represented are only to be understood as exemplary. Thus, for example, other metals may also be used instead of the material tungsten as a second filler 174, or also non-metallic fillers, which are markedly heavier than matrix material 170, e.g., the silicone.

In the course of the method, the above-described, optional method steps are represented by example in FIG. 9. The individual components of the above-described method are designated there in an exemplary manner by reference numeral 182. Reference numeral 184 generally refers to one or more mixing steps. Reference numeral 186 denotes the mixed components. The admixture of hardener component 178 is denoted by reference numeral 188. Reference numeral 190 refers to non-cured damping material 142. Reference numeral 192 generally denotes a curing process. On top of that, however, reference numeral 192 may also still denote various other method steps, such as mixing and/or degassing and/or dispensing, in particular, introducing non-cured damping material 190 into interior chamber 126. Furthermore, reference numeral 192 may even encompass gelling, as described above. Finally, the cured damping material is denoted by reference numeral 194.

1-13. (canceled)

14. An ultrasonic transducer for use in a fluid medium, comprising:
at least one housing;
at least one transducer core at least partially accommodated in the at least one housing, wherein the transducer core includes at least one acoustic-electric transducer element; and
at least one damping material accommodated in the housing, the at least one damping material having at least one matrix material, wherein at least one first filler is introduced into the matrix material, wherein at least one second filler is introduced into the matrix material, wherein the first filler has a lower specific gravity than the matrix material, and wherein the second filler has a higher specific gravity than the matrix material.

15. The ultrasonic transducer of claim 14, wherein the matrix material includes a curable plastic, which includes a silicone material.

16. The ultrasonic transducer of claim 14, wherein in the non-cured state, the matrix material has at least one of the following properties: (i) a viscosity of at least 200 mPas, and (ii) thixotropic characteristics.

17. The ultrasonic transducer of claim 14, wherein the first filler is selected from: hollow bodies; hollow bodies having a deformable shell; hollow plastic bodies; and hollow glass bodies.

18. The ultrasonic transducer of claim 14, wherein under normal conditions, the first filler includes particles having a maximum size of 200 μm.

19. The ultrasonic transducer of claim 14, wherein the first filler has a specific gravity of no more than 1.0 g/cm³.

20. The ultrasonic transducer of claim 14, wherein a weight percentage of the first filler is at least 0.05% of the damping material.

21. The ultrasonic transducer of claim 14, wherein the second filler is selected from at least one of: a metal; a chemical compound including a metal; and a powdery filler.

22. The ultrasonic transducer of claim 14, wherein the second filler has a specific gravity of at least 5 g/cm³.

23. The ultrasonic transducer of claim 14, wherein the second filler includes a powder having a particle size of no more than 50 μm.

24. The ultrasonic transducer of claim 14, wherein a weight percentage of the second filler is at least 15% of the damping material.

25. A method for manufacturing an ultrasonic transducer, the method comprising:
introducing at least one transducer core at least partially into a housing, the transducer core including at least one acoustic-electric transducer element;
introducing at least one damping material into the housing; and
introducing at least one matrix material, at least one first filler being introduced into the matrix material, and at least one second filler being introduced into the matrix material, being included in the damping material;
wherein the first filler has a lower specific gravity than the matrix material, and wherein the second filler has a higher specific gravity than the matrix material.

26. The method of claim 25, wherein the matrix material includes at least one curable material, and wherein the curable material is introduced into the housing in a non-cured state and is subsequently cured.

27. The ultrasonic transducer of claim 14, wherein in the non-cured state, the matrix material has at least one of the following properties: (i) a viscosity of at least 500 mPas, and (ii) thixotropic characteristics.

28. The ultrasonic transducer of claim 14, wherein the first filler is selected from: hollow spheres; hollow bodies having a plastic shell; hollow gas-filled, plastic bodies; and gas-filled, hollow glass bodies.

29. The ultrasonic transducer of claim 14, wherein under normal conditions, the first filler includes particles having a maximum size of 100 μm.

30. The ultrasonic transducer of claim 14, wherein under normal conditions, the first filler includes particles having a maximum size of less than 20 μm.

31. The ultrasonic transducer of claim 14, wherein the first filler has a specific gravity of no more than 0.5 g/cm³.

32. The ultrasonic transducer of claim 14, wherein the first filler has a specific gravity of no more than 0.1 g/cm³.

33. The ultrasonic transducer of claim 14, wherein the first filler has a specific gravity of no more than 0.08 g/cm³.

34. The ultrasonic transducer of claim 14, wherein a weight percentage of the first filler is at least at least 0.15% of the damping material.

35. The ultrasonic transducer of claim 14, wherein a weight percentage of the first filler is at least 0.5% of the damping material.

36. The ultrasonic transducer of claim 14, wherein the second filler is selected from at least one of: tungsten; tungsten carbide; copper; nickel; nickel brass; bronze; a chemical compound including a metal oxide having one of the above-mentioned metals; a metal powder; and a ceramic powder.

37. The ultrasonic transducer of claim 14, wherein the second filler has a specific gravity of at least 10 g/cm³.

38. The ultrasonic transducer of claim 14, wherein the second filler has a specific gravity of at least 15 g/cm³.

39. The ultrasonic transducer of claim 14, wherein the second filler includes a powder having a particle size of no more than 10 μm.

40. The ultrasonic transducer of claim 14, wherein the second filler includes a powder having a particle size of no more than 5 μm.

41. The ultrasonic transducer of claim 14, wherein the second filler includes a powder having a particle size of no more than 2 μm.

42. The ultrasonic transducer of claim 14, wherein a weight percentage of the second filler is at least at least 50% of the damping material.

43. The ultrasonic transducer of claim 14, wherein a weight percentage of the second filler is at least at least 66% of the damping material.
